(19) United States
(12) Patent Application Publication
(10) Pub. No.: US 2011/0199267 A1
(43) Pub. Date: Aug. 18, 2011

(54) ANTENNA DEVICE

(75) Inventor: Toshiteru Hayashi, Kanagawa (JP)

(73) Assignee: PANASONIC CORPORATION, Osaka (JP)

(21) Appl. No.: 13/124,823

(22) PCT Filed: Aug. 27, 2009
(86) PCT No.: PCT/JP2009/004182

§ 371 Date: Apr. 18, 2011

(30) Foreign Application Priority Data
Oct. 20, 2008 (JP) 2008-269988

(51) Int. Cl. H01Q 9/04

(52) U.S. Cl. 343/700 MS

(57) ABSTRACT

Provided is an antenna device having excellent antenna characteristics at desired frequencies by suppressing influences to a human body and the like to minimum. In the device, a power feeding section (102) is arranged on a ground plate (101). An antenna element (103) has a section (112) to be fed with power supplied from the power feeding section (102), a grounding section (111) grounded to the ground plate (101), and a main body section (113) formed by making the surfaces of a conductive plate face each other by folding the conductive plate midway. The section (112) to be fed with power and the grounding section (111) form a reverse F-shape by being connected to the main body section (113), and are arranged at an end portion of the ground plate (101).

### TECHNICAL FIELD

The present invention relates to an antenna apparatus to constitute a wideband antenna that reduces the current flow on a ground plate.

### BACKGROUND ART

A planar-inverted F antenna (PIFA) is known as an antenna to mount on a small mobile terminal (see, for example, patent literature 1). With the antenna disclosed in patent literature 1, a ground plate is connected with a conductor ground plate through metallic wiring and is fed power from a power feeding point through metallic wiring. Also, one end of a conductor wall is electrically connected with the ground plate, and an electromagnetic coupling adjusting plate is electrically connected with the other end of the conductor wall. The electromagnetic coupling adjusting plate is placed a certain gap apart from the conductor ground plate, so that a capacitor is formed between the electromagnetic coupling adjusting plate and the conductor ground plate. By this means, it is possible to make an antenna's frequency characteristics to support wideband characteristics.

### CITATION LIST

### Patent Literature

PTL 1
Japanese Patent Application Laid-Open No. 2002-223114

### SUMMARY OF INVENTION

### Technical Problem

However, with the antenna disclosed in patent literature 1, when this antenna oscillates, a large amount of current flows on the ground plate of a mobile terminal, due to the electromagnetic coupling adjusting plate. Consequently, when the user holds the casing of the mobile terminal, the current flowing on the ground plate changes significantly, and, furthermore, the human body influences as a dielectric and causes an impedance mismatch in the antenna. As a result of this, there is a problem that intended antenna characteristics cannot be achieved and the mobile terminal suffers deterioration of wireless communication quality.

FIG. 1(a) shows voltage standing wave ratio (VSWR) characteristics in the event a mobile terminal is placed in free space, and FIG. 1(b) shows VSWR characteristics in the event a mobile terminal is placed near the human body. In FIG. 1(a) and FIG. 1(b), the horizontal axis is frequency and the vertical axis is VSWR, which shows the level of antenna impedance matching. When VSWR is 1, the best impedance matching is shown.

In FIG. 1(a), an oscillation occurs at desired frequency f₀. That is to say, the best impedance matching is shown at desired frequency f₀. By contrast with this, in FIG. 1(b), due to the influence of the human body, an oscillation occurs at frequency fs, shifted to the lower frequency side compared to above desired frequency f₀ in the event of free space.

Consequently, even if design is made to match the desired frequency of a mobile terminal in free space, due to the influence of the human body and so on, impedance matching cannot be seen at that desired frequency. As a result of this, there is a problem of instability of communication, and communication might even be disconnected in the worst scenario. In particular, when a large amount of current flows on the ground plate, the above problem becomes more obvious.

It is therefore an object of the present invention to provide an antenna apparatus that can minimize the influence of the human body and make antenna characteristics at a desired frequency good.

### Solution to Problem

An antenna apparatus according to the present invention adopts a configuration having: a ground plate; a power feeding section that is provided in the ground plate; and an antenna element having a power-fed section where power is fed from the power feeding section, a grounding section that is grounded to the ground plate, and a main body section that is formed by bending back a conductor plate in the middle so that the conductor plate has mutually opposing surfaces, the antenna element having an inverted F shape connecting the power-fed section, the ground section, and the main body section, and being placed in an edge section of the ground plate.

### Advantageous Effects of Invention

With the present invention, it is possible to reduce the influence of the human body and make antenna characteristics at a desired frequency good.

### BRIEF DESCRIPTION OF DRAWINGS

FIG. 1 shows conventional VSWR characteristics;

FIG. 2 is a perspective view of an antenna apparatus according to embodiment 1 of the present invention;

FIG. 3 is a plan view of an antenna apparatus according to embodiment 1 of the present invention;

FIG. 4 is a side view of an antenna apparatus according to embodiment 1 of the present invention;

FIG. 5 is a front view of an antenna apparatus according to embodiment 1 of the present invention;

FIG. 6 shows current distribution characteristics on a ground plate according to embodiment 1 of the present invention;

FIG. 7 shows VSWR characteristics according to embodiment 1 of the present invention;

FIG. 8 shows the relationship between an unequal median value, and user throughput during MIMO communication;

FIG. 9 is a perspective view of an antenna apparatus according to embodiment 2 of the present invention;

FIG. 10 is a plan view of an antenna apparatus according to embodiment 2 of the present invention;

FIG. 11 is a front view of an antenna apparatus according to embodiment 2 of the present invention; and

FIG. 12 shows VSWR characteristics according to embodiment 2 of the present invention.

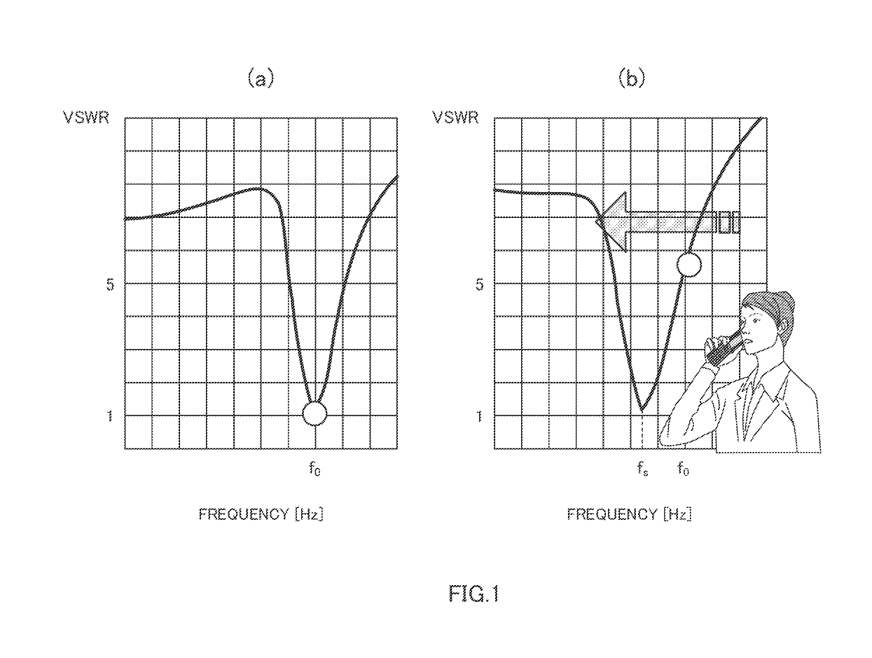

### DESCRIPTION OF EMBODIMENTS

Now, embodiments of the present invention will be described in detail with reference to the accompanying drawings.

### Embodiment 1

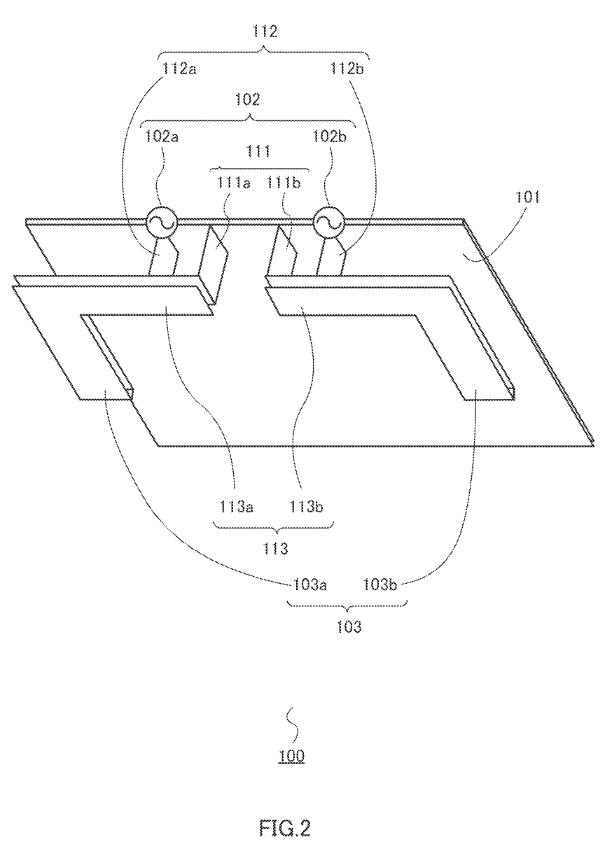

FIG. 2 is a perspective view of antenna apparatus 100 according to embodiment 1 of the present invention.

From FIG. 2, antenna apparatus 100 is configured primarily with ground plate 101, power feeding section 102 and antenna element 103. Antenna apparatus 100 has a pair of power feeding sections 102a and 102b and a pair of antenna elements 103a and 103b.

Ground plate 101 has power feeding section 102. Ground plate 101 is formed with, for example, a conductive case, a circuit board on which a ground pattern is printed, and so on.

Power feeding section 102 is provided on ground plate 101.

Antenna element 103 is provided in an edge section of ground plate 101. Also, antenna element 103 is formed by a conductor plate and has an inverted-F shape connecting grounding section 111, power-fed section 112 and main body section 113 as one, and functions as an inverted-F antenna. Also, antenna element 103 is formed by, for example, forming grounding section 111 and main body section 113 as one by processing conductive (metallic, for example) members and furthermore by welding power-fed section 112 to main body section 113.

Grounding section 111 is bent vertically from main body section 113 and is formed as one with main body section 113, and attached vertically with respect to ground plate 101. Also, ground section 111 is grounded by being electrically connected to the ground of ground plate 101.

Power-fed section 112 is attached vertically with respect to main body section 113, electrically and mechanically connected with main body section 113, and attached vertically with respect to ground plate 101. Also, power-fed section 112 is fed power from power feeding section 102. Also, the length of the long side of power-fed section 112 (the vertical direction with respect to ground plate 101) is virtually the same as in grounding section 111, and power-fed section 112 is attached to ground plate 101a predetermined distance apart from grounding section 111 parallel to grounding section 111.

Main body section 113 is formed by bending a conductor plate in the middle so that the conductive plate has opposing surfaces. Also, main body section 113 is placed parallel to ground plate 101.

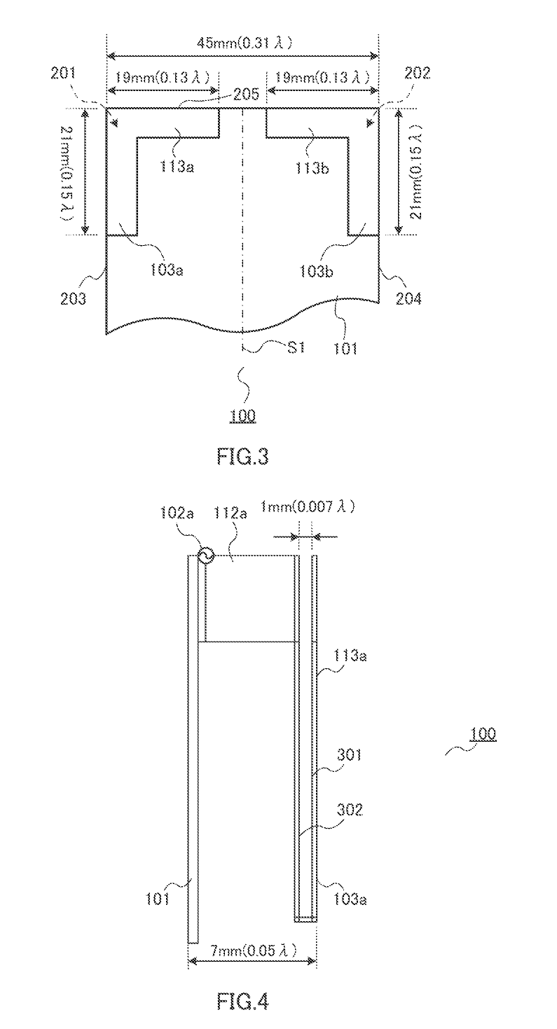

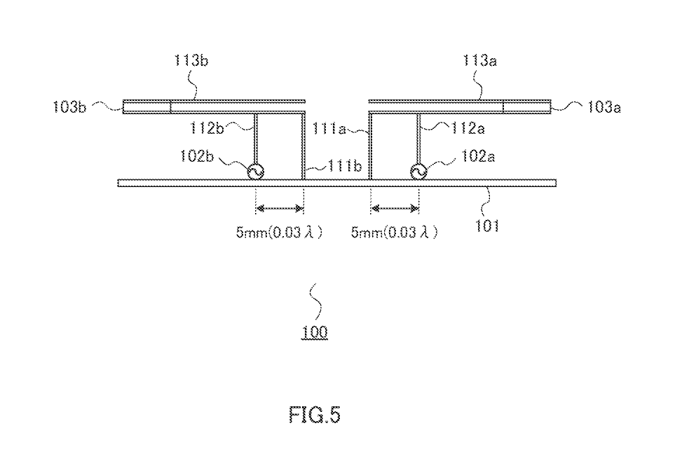

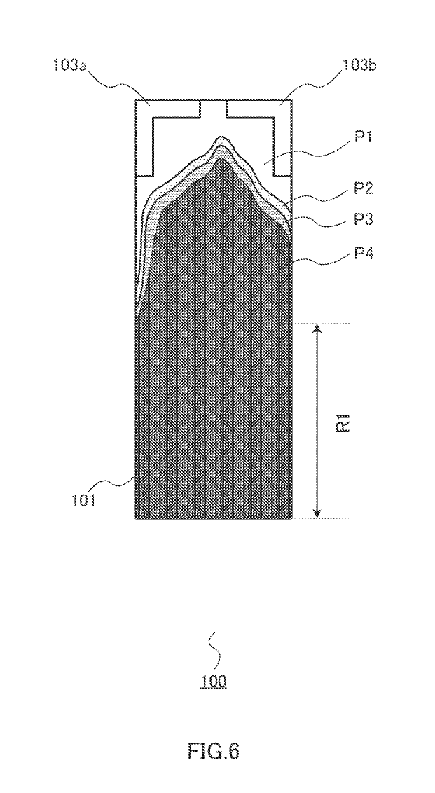

Next, the configuration of antenna element 103 will be described in detail using FIGS. 3 to 5. FIG. 3 is a plan view of antenna apparatus 100, FIG. 4 is a side view of antenna apparatus 100, and FIG. 5 is a front view of antenna apparatus 100.

As shown in FIG. 3, main body section 113a of antenna element 103a is formed in an L shape on a planar view, and main body section 113b of antenna element 103b is formed in an inverted-L shape on a planar view. Also, main body sections 113a and 113b are formed such that the long side that is 21 mm (0.15λ) long in the long direction and the short side that is 19 mm (0.13λ) in the short direction meet vertically. In ground plate 101, long side 203 and short side 205 meet vertically and form corner section 201, and long side 204 and short side 205 meet vertically and form corner section 202. Also, main body section 103a of antenna element 103a is placed in corner section 201 along long side 203 and short side 205 forming corner section 201. Likewise, main body section 113b of antenna element 103b is placed in corner section 202 along long side 204 and short side 205 forming corner section 202. Also, short side 205 of ground plate 101 is 45 mm (0.31λ) long.

Also, as shown in FIG. 4, main body section 113a of antenna element 103a is formed by bending back a conductor plate in the middle so that surface 302 of the conductor plate before the bending point and surface 301 of the conductor plate that is bent backward meet at a distance of 1 mm (0.007λ). Also, antenna element 103a is placed on ground plate 101 such that the distance between main body section 113a that is bent back, and ground plate 101, is 7 mm (0.05λ). Although not shown in FIG. 4, the same applies to antenna element 103b, and so its description will be omitted.

Also, referring to FIG. 5, antenna element 103a is formed such that the distance between grounding section 111a and power-fed section 112a is 5 mm (0.03λ). Also, antenna element 103b is formed such that the distance between grounding section 111b and power-fed section 112b is 5 mm (0.03λ).

The dimensions of the antenna elements shown in FIG. 3 to FIG. 5 are only examples but are by no means limited to these dimensions insofar as having the antenna element configuration shown in FIG. 2.

FIG. 6 shows current distribution characteristics on ground plate 101 according to the present embodiment. Referring to FIG. 6, ground plate 101 of the casing of a communication terminal apparatus has a current distribution where the current value increases closer to antenna elements 103a and 103b (where P1>P2>P3>P4 and where P1 through P4 show current values (A/m)). That is to say, the current distribution according to the present embodiment is concentrated near antenna elements 103a and 103b in the event ground plate 101 is attached to the casing of the communication terminal apparatus (not shown) and does not distribute over the entirety of ground plate 101. Consequently, the current value in area R1, by which the user holds the mobile terminal, is 4, which is the smallest current value.

With the present embodiment, main body section 113a of antenna element 103a and main body section 113b of antenna element 103b are symmetric with respect to the line connecting between the middles of opposing short sides of ground plate 101 (the short side to oppose short side 205 is not shown in FIG. 2 and FIG. 3), and are arranged to along short side 205 and long side 203, or short side 205 and long side 204. By this means, provision is made to concentrate current distribution in an antenna element and prevent current distribution from showing in area R1, so that it is possible to reduce the current distribution in ground plate 101. This is because the current that flows in main body sections 113a and 113b of the bent-back parts of antenna elements 103a and 103b and the current that flows in main body sections 113a and 113b of the unbent parts flow in directions to cancel each other.

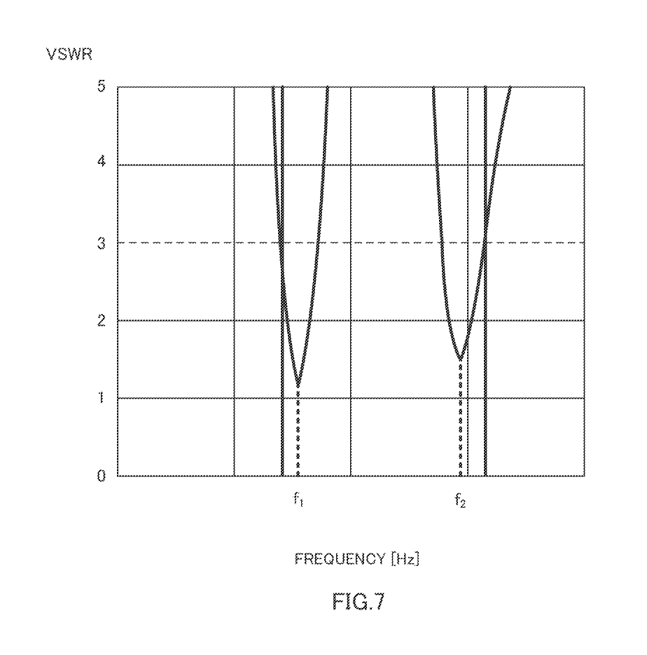

FIG. 7 shows VSWR characteristics according to the present embodiment. As shown in FIG. 7, with the present embodiment, antenna apparatus 100 functions as a multi-band antenna having oscillating frequencies of frequency f1 and frequency f2.

Incidentally, in MIMO communication, if part of a plurality of antennas is influenced by the human body, variations in receiving power are produced between antennas (i.e. unequal median value). As a result of this, in MIMO communication, communication performance (transmission rate) lowers due to deterioration of antenna characteristics or deterioration of reception.

Conventionally, in a mobile terminal performing MIMO communication using a plurality of antennas, when a user holds the mobile terminal by his hand, for example, the user's hand is situated near one antenna (antenna #1), and therefore antenna characteristics deteriorate and the receiving power lowers. In this case, power difference ΔG [dB] is produced between antenna #1 and the other antenna (antenna #2). Power difference ΔG results in an unequal median value between antennas, and, if this power difference ΔG increases, MIMO communication performance lowers.

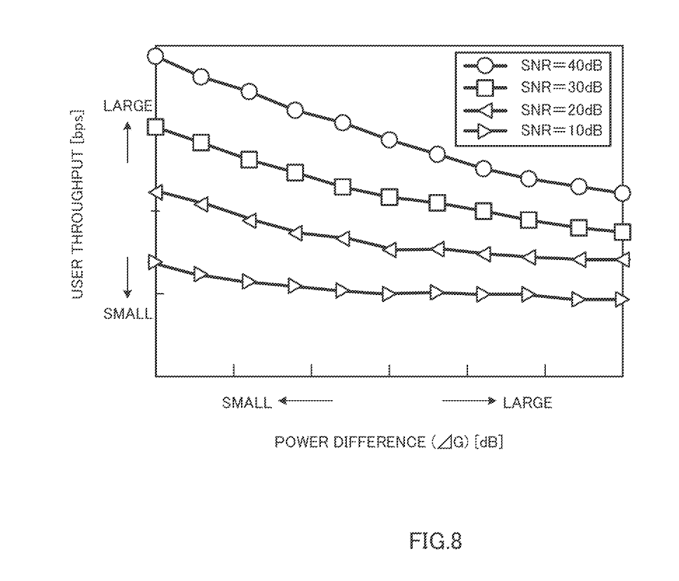

FIG. 8 shows relationship between the unequal median value and user throughput during MIMO communication. Now, for example, user throughput [bps] represents the level of high-speed transmission in a quantitative manner, and, for example, downloading can be finished in a shorter time if throughput increases. As shown in FIG. 8, if unequal median value increases, user throughput during MIMO communication lowers.

However, with the present embodiment, current distribution is concentrated in antenna elements and the current distribution near the part (area R1) which the user holds by his hand lowers, so that an impedance mismatch due to the user's hand being located near an antenna element of a mobile terminal is less likely to occur. That is to say, with the present embodiment, the influence upon deterioration of antenna characteristics is less and the power difference that is produced between antenna element 103a and antenna element 103b can be alleviated, so that it is possible to achieve good antenna characteristics in MIMO communication and prevent communication performance from lowering.

Antenna apparatus 100 of the present embodiment is applicable to a communication terminal apparatus such as a mobile telephone. By this means, it is possible to provide a communication terminal apparatus to support multi-band communication or MIMO communication.

By this means, with the present embodiment, it is possible to reduce the influence of the human body and so on and make the antenna characteristic at desired frequency good by reducing the current distribution in the ground plate. Also, with the present embodiment, it is possible to achieve good communication performance when performing MIMO communication, by a simple configuration. Also, with the present embodiment, by making an antenna in a simple configuration, it is possible to save space and miniaturize the apparatus.

### Embodiment 2

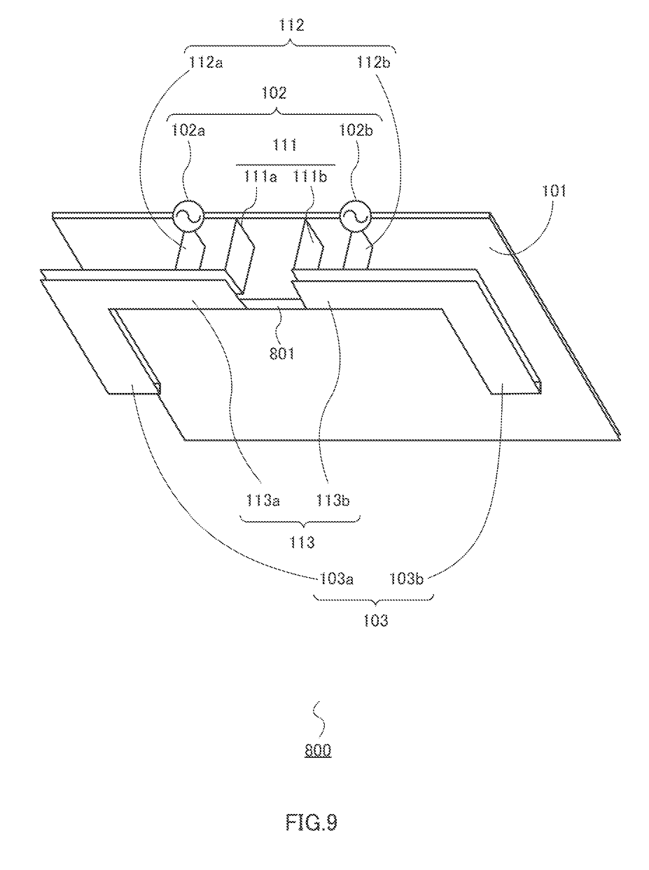

FIG. 9 is a perspective view of antenna apparatus 800 according to embodiment 2 of the present invention.

Antenna apparatus 800 shown in FIG. 9 is configured by adding short-circuit section 801 to antenna apparatus 100 according to embodiment 1 of FIG. 2. Incidentally, parts in FIG. 9 that are the same as in FIG. 2 will be assigned the same reference codes as in FIG. 2, and their detailed descriptions will be omitted.

Short-circuit section 801 is short-circuited by connecting main body section 113a of antenna element 103a and main body section 113b of antenna element 103b electrically. Also, short-circuit section 801 short-circuits the edge sections of the bent-back parts of main body sections 113a and 113b mutually.

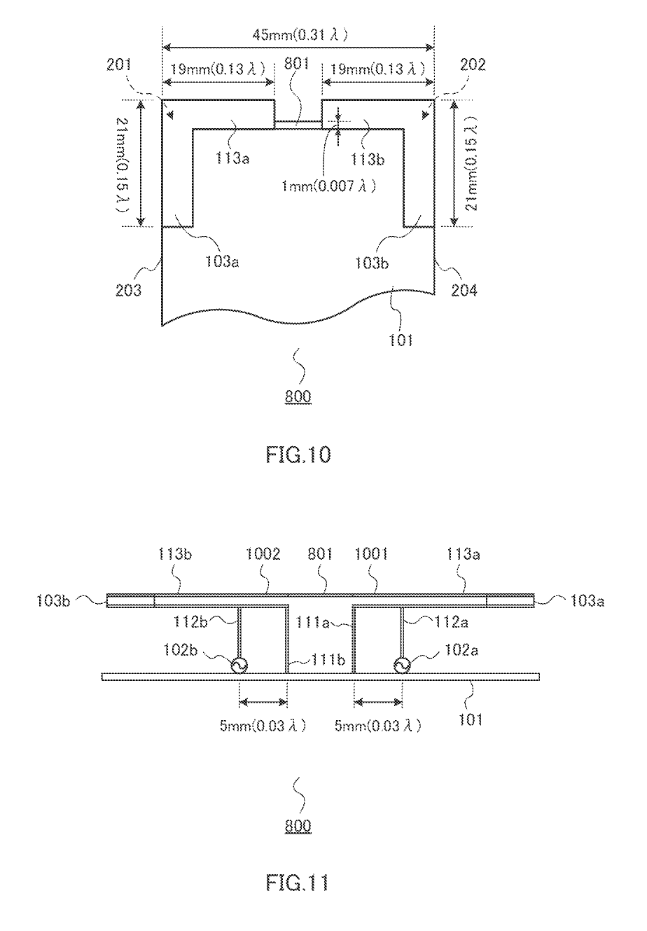

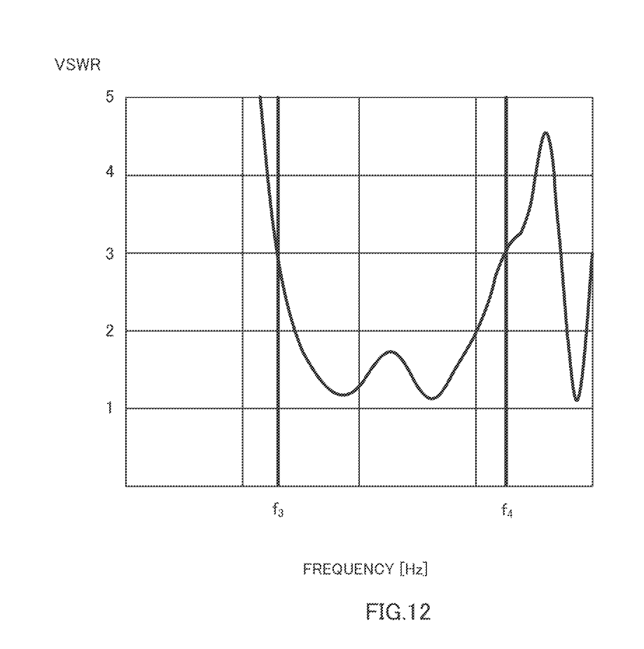

Next, a configuration of antenna element 103 and short-circuit section 801 will be described in more detail using FIG. 10 and FIG. 11. FIG. 10 is a plan view of antenna apparatus 800 and FIG. 11 is a front view of antenna apparatus 800.

As shown in FIG. 10, short-circuit section 801 is 1 mm (0.007λ) long in the short direction (upper and lower directions in FIG. 10). Incidentally, the rest of the configurations are the same as in FIG. 3, and their descriptions will be omitted.

Also, as shown in FIG. 11, short-circuit section 801 short-circuits bent-back edge section 1001 of main body section 113a and bent-back edge section 1002 of main body section 113b mutually. The rest of the configurations are the same as in FIG. 5, and so their descriptions will be omitted.

FIG. 12 shows the VSWR frequency characteristics of the present embodiment. As shown in FIG. 12, with the present embodiment, antenna apparatus 800 functions as a wideband antenna that can oscillate at frequency f3 and frequency f4.

Antenna apparatus 800 of the present embodiment is applicable to a mobile telephone and suchlike communication terminal apparatuses. By this means, it is possible to provide a communication terminal apparatus to support wideband communication.

By this means, with the present embodiment, in addition to the above advantage of embodiment 1, it is possible to configure an antenna that can oscillate in wideband, and configure a multi-band antenna (wideband antenna) that supports various systems and frequencies, in a simple configuration.

The disclosure of Japanese Patent Application No. 2008-269988, filed on Oct. 20, 2008, including the specification, drawings and abstract, is incorporated herein by reference in its entirety.

### INDUSTRIAL APPLICABILITY

An antenna apparatus according to the present invention is suitable to configure a wideband antenna that reduces the current to flow in the ground plate.

1. An antenna apparatus comprising:
a ground plate;
a power feeding section that is provided in the ground plate; and
an antenna element having a power-fed section where power is fed from the power feeding section, a grounding section that is grounded to the ground plate, and a main body section that is formed by bending back a conductor plate in the middle so that the conductor plate has mutually opposing surfaces, the antenna element having an inverted F shape connecting the power-fed section, the ground section, and the main body section, and being placed in an edge section of the ground plate.

2. The antenna apparatus according to claim 1, wherein a plurality of antenna elements are provided such that each power-fed section is fed power from the power feeding section.

3. The antenna apparatus according to claim 1, wherein the antenna element has a pair of power-fed sections, a pair of grounding sections, and a pair of main body sections, and has a short-circuit section that short-circuits bent-back parts of the main body sections mutually.

4. A communication terminal apparatus comprising the antenna apparatus of claim 1.
